(19) United States
(12) Patent Application Publication
(10) Pub. No.: US 2004/0184898 A1
(43) Pub. Date: Sep. 23, 2004

(54) Fastener having guide rails

(75) Inventors: Mark A. Farrell, Conroe, TX (US); Michael E. Farrell, Murrieta, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(73) Assignee: EVENING STAR INTERNATIONAL, LLC

(21) Appl. No.: 10/393,864

(22) Filed: Mar. 21, 2003

(51) Int. Cl. F16B 15/08

(52) U.S. Cl. 411/450

(57) ABSTRACT

A fastener for securing work pieces together including a metal substrate, the fastener includes an elongated flat body having a driving head disposed at substantially right angles to the body, a point at the end opposite the head for penetrating the work pieces including the metallic substrate guide rails extend along each side edge of the elongated flat body and in a plane defined by the elongated flat body. The guide rails are adapted to fit within a pair of guide channels formed in a power tool adapted to insert the fastener through the work piece and the metallic substrate. The guide rails in the guide channel of the power tool maintain the fastener substantially perpendicular to the surface of the work piece during installation.

### FIELD OF THE INVENTION

The present invention relates generally to fasteners and more particularly to a metal piercing fastener for securing one or more metal/non-metal layers to at least one metal layer and retaining the secured layers in their positions permanently under adverse conditions.

### BACKGROUND OF THE INVENTION

Securing work pieces together, such as, for example, a top laminate non metal work piece to a bottom light-gauge metal substrate (18 gauge and thinner) or alternatively, a light-gauge metal work piece to light-gauge metal substrate (LGSM) have generally been accomplished by using threaded fasteners. The helical design of the thread on such fasteners has been successful in pulling the top laminate materials together tightly with the light-gauge metal substrate. Additionally, the helical thread design has provided sufficient withdrawal resistance to achieve performance values acceptable to the construction industry. However, installation of helical threaded fasteners has proven time-consuming and fatiguing to the installer. The industries using these light-gauge metals require a fastener that has the speed of pneumatic nailing system with the gripping and clamping features of helical-thread fasteners.

Nail-like products (hardened pins) have been used successfully in attaching work pieces (including a top metal member) to heavier gauge metal substrates (16 gauge and thicker). However, when the metal substrate is of light-gauge metal (18 gauge and thinner) or two or more pieces of light-gauge metal (18 gauge and thinner) are to be joined together, the substrate may be pushed away (deflection) from the top member before the penetration and fastening process is completed. Additionally, the thinness of these metals is such that is creates situations where there is insufficient material to provide a friction-lock for current state-of-the-art pins. Whether they incorporate barbs, protrusions, undercuts, cross-hatching or spiral threads, these hardened pins lack withdrawal resistance when installed in these light-gauge metal materials. Additionally, they lack the ability to pull the substrate and the work piece together to close the gap between them caused by the deflection when the metal substrate is of light-gauge metal.

L. H. Flora (U.S. Pat. No. 2,740,505 and U.S. Pat. No. 2,751,052), discloses a one-piece, spring steel roofing nail for attaching insulation to a sheet metal deck. This roofing nail incorporates a center tongue within a cutout of the body, a point piercing the light-gauge metal deck, and a head, bent in an angle from the same material as the body, used for clamping of the insulation layer. The body includes elongate ribs which are incorporated to stiffen and ridgify the body. In Dimas (U.S. Pat. No. 3,983,779), such ribs are also incorporated but are formed in a more arcuate manner than an acute bend. McChesney (U.S. Pat. No. 1,934,134) also discloses a fastener in the form of a tack for holding two pieces of wood together. This tack is formed from a continuous strip of flat wire which is swaged on both side edges to form converging side flanges which provide a wedge shaped appearance to the width dimension of the web between the side flanges. The provision of such ribs or side flanges (Flora, Dimas or McChesney) dramatically increases driving forces necessary for installation of the nail. In the low-density laminate (insulation) for which both Flora and Dimas have developed their roofing nail and wood for which McChesney developed his tack driving resistance may not be a problem. However, when denser laminates (i.e., gypsum board, plywood, oriented-strand board, cement board) are being fastened to a metal substrate, driving forces encountered are of such nature as to possibly cause incomplete installation. When a commercial pneumatic tool is used for power installation, these added driving forces are enough to “stall-out” the tool. In accordance with the principles of the present invention, for successful fastener installation using a commercial power tool through work pieces of denser material than insulation, the fastener body should be of a design having minimal driving resistance. As a result stiffening ribs or any other protrusions extending transversely from the plane of the body should be avoided.

Therefore, the need arises for a self-piercing fastener which may be fabricated from relatively thin, hardened and resilient material such as light gauge sheet metal (LGSM) and which may be used with a power tool adapted to accommodate the fastener for attaching relatively non-compressible work pieces to a metal substrate. The power tool user would require little or no training at all and would actuate the power tool by pulling a trigger, pushing a button or the like.

The need also arises for a novel fastener which may have a relatively low profile body equipped with a head at one end and a piercing tip or point at the other end. Such a fastener should have high tensile and shear values as well as optimized gripping and clamping capability. When the fastener is propelled, via a high velocity impact tool, it should be capable of effectively penetrating thin LGSM sheet with an insignificant occurrence of deflection. The fastener may also be provided with resilient gripping and clamping elements, “tines”, which can be integrally formed from the body.

Such a fastener is illustrated and described generally in application Ser. No. 09/724,333; filed Nov. 28, 2002 for METAL PIERCING FASTENER by the Applicant's of the present application which previous application is incorporated herein by this reference.

The fastener disclosed therein is a metal piercing fastener for securing a first member to a second metal member, the fastener comprising a blade having first and second ends and first and second side edges formed from sheet spring material having a uniform thickness and a width substantially greater than the thickness; a head protrudes from the first end of the blade, the second end of the blade defines a metal penetrating region, the head being adapted to receive an impact blow from a power tool to drive the metal penetrating region through the second metal member; the blade defines a slot spaced inwardly from the first and second side edges and terminating adjacent the second end to provide a free standing separate resilient tine extending upwardly from the second end of the blade and terminating intermediate the first and second ends, a plurality of protruding elements are formed on the edges of the tine with each protruding element having a cam surface facing toward the second end for engaging the second metal member to urge the tine into the slot as the fastener passes through the metal work piece. The first and second side edges and the metal piercing region of the blade may be coined if desired. The present invention is a improvement over the metal fastener disclosed in the above-identified application.

Although the fastener as disclosed in the above-identified application works extremely well, it has been discovered that to drive the fastener through the work piece and the metal substrate it is imperative that the fastener be maintained substantially perpendicular to the surface of the work piece in order for the fastener to fully penetrate the work piece and the substrate with the velocity of insertion available from the traditional power tools used to drive such fasteners. As a result, the fastener of the present invention has been designed to include guide rails which cooperate with the power tool to insure such perpendicularity during insertion of the fastener into the work piece and the metal substrate.

### SUMMARY OF THE INVENTION

A fastener for securing a work piece to a metal substrate includes an elongated flat body having a point for penetrating the work piece and a substrate and has a width dimension and an outer edge. A securing member is carried by the body. A head having a width dimension is disposed at one end of the body for driving the fastener through the work piece and the substrate. The width dimension of the head is smaller than the body width dimension thus providing unobstructed side edge guide rails.

### BRIEF DESCRIPTION OF THE DRAWINGS

FIG. 1 is a perspective view of a fastener constructed in accordance with the present invention;

FIG. 2 is a side elevational view of the fastener illustrated in FIG. 1;

FIG. 3 is a plan view showing the fastener prior to the portion forming the head being bent;

FIG. 4 is a cross-sectional view of the body of the fastener of the present invention taken about the lines 4-4 of FIG. 1;

FIG. 5 is a partial cross-sectional view of the body of the fastener illustrated in FIG. 1 taken about the lines 5-5 thereof; and

FIG. 6A, 6B and 6C are illustrations showing a fastener of the present invention being installed.

### DETAILED DESCRIPTION

A fastener constructed in accordance with the present invention eliminates substantially all protrusions from that portion of the flat elongated body of the fastener which penetrates the metallic substrate to thus minimize the friction involved as the fastener penetrates the metallic substrate. In addition, the width dimension of the body of the fastener is formed to be greater than the width dimension of the head. Such a profile produces a pair of guide rails, one along each side of the flat elongated body lying in the plane defined by the flat elongated body, which cooperate with guide channels formed in the power tool to maintain the fastener substantially perpendicular to the work piece during the time the power tool drives the fastener through the work piece and through the metal substrate to a position such that the substrate and the work piece can be clamped together.

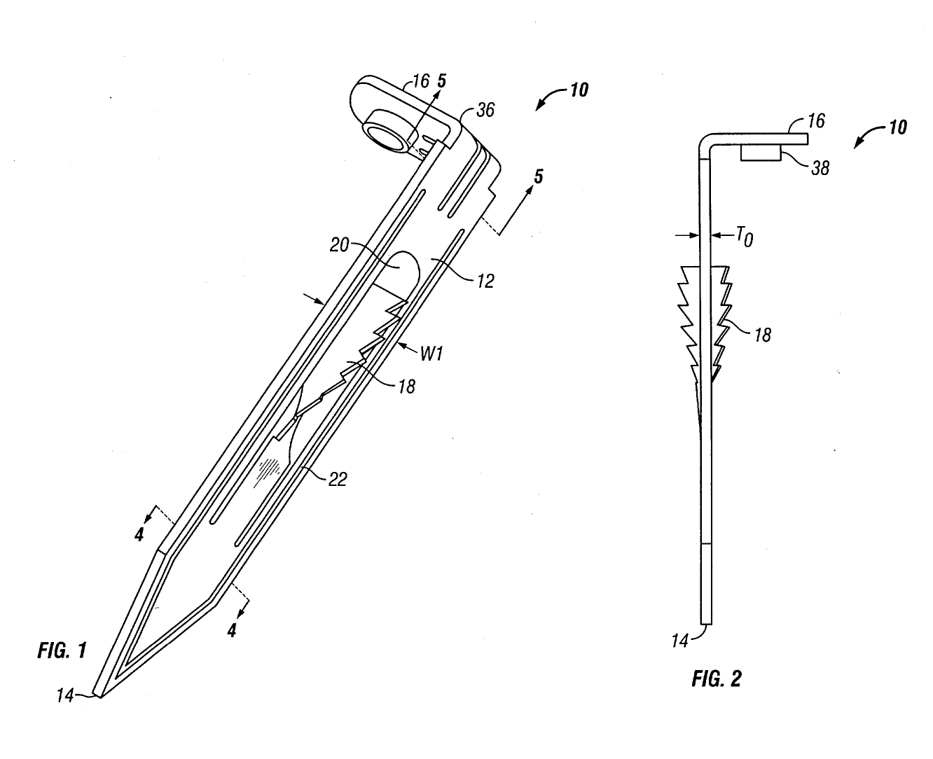

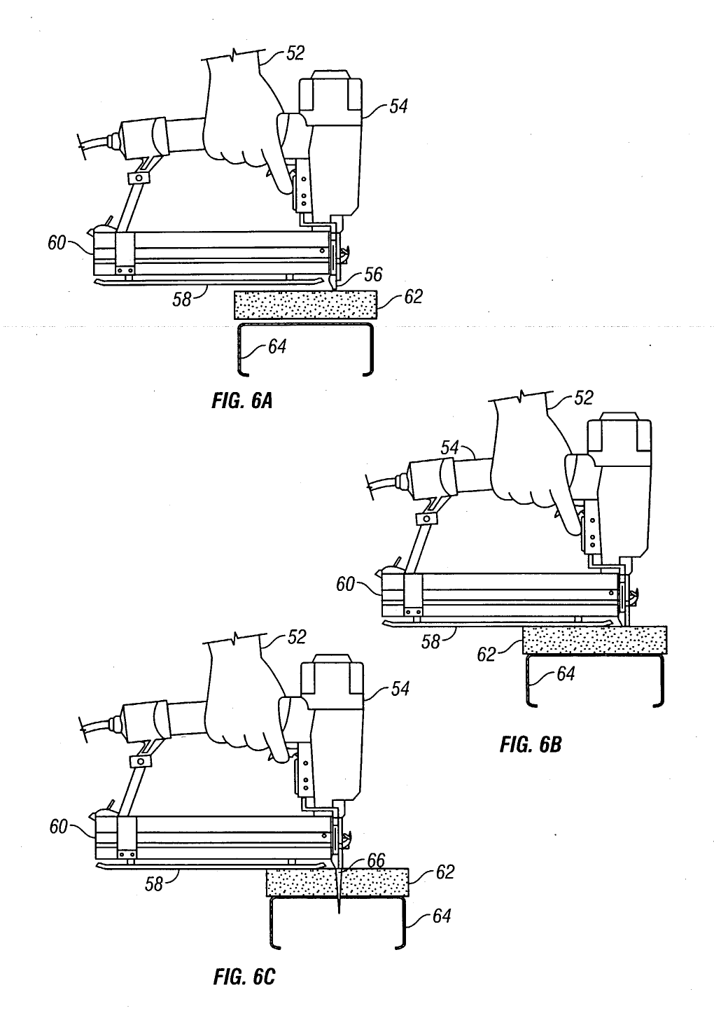

These and other features of the fasteners constructed in accordance with the principles of the present invention are illustrated in the drawings to which reference is hereby made. As is shown, in FIGS. 1 through 5, the fastener 10 includes a flat elongated body 12 having a point 14 for penetrating the work piece and the metal substrate. Provided at the opposite end of the elongated body 12 is a head 16 adapted for engagement by a power tool (FIG. 6) to drive the fastener 10 through the work piece and the metal substrate. A securing member 18 is carried by the body 12 for securing the work piece and the metallic substrate together after insertion. The securing member 18 as illustrated in FIG. 1 is a tine which is disposed within an opening 20 formed in the body 12. The tine extends from the lower portion of the opening and protrudes upwardly into it. As is shown in FIG. 1, the tine is twisted (although it may be otherwise deformed about its longitudinal axis) and as it passes through the aperture formed in the substrate by the point 14 it flattens into the opening 20 and does not distort the aperture dimensions. The securing member then by friction from the edges locking within the formed aperture holds the work piece and the metal substrate together. The body 12 of the fastener 10 has a width dimension W1 and the head 16 has a width dimension W2.

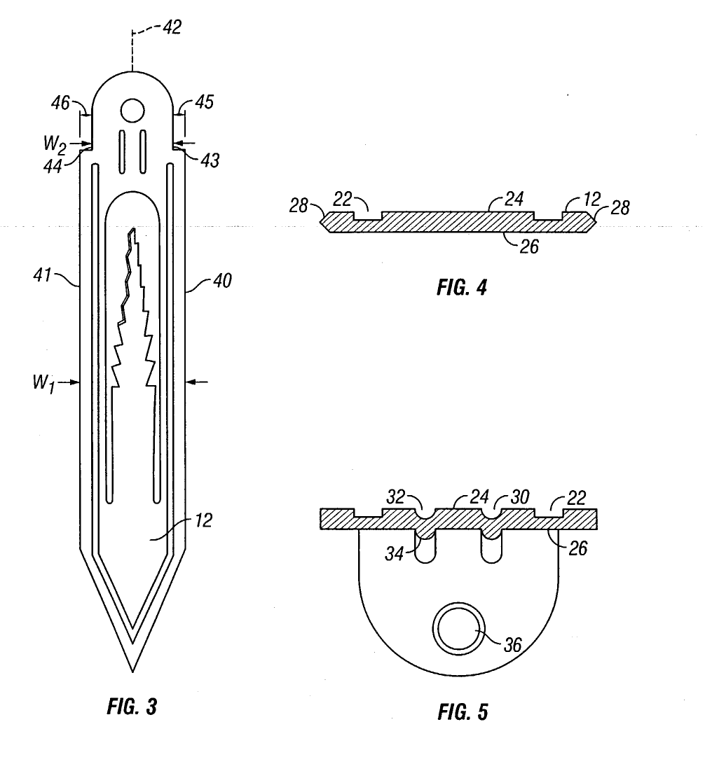

Referring now more particularly to FIG. 3, the manner in which the guide rails are formed is illustrated in greater detail. As is therein shown, the body 12 of the fastener 10 has a width dimension W1 and first and second side edges 40 and 41. The body also defines a longitudinal axis 42. The head 16 has a width dimension W2 and has first and second side edges 43 and 44. The width dimension W1 of the body is greater than the width dimension W2 of the head. As a result, as it is seen in FIG. 3 the side edges 43 and 44 of the head 16 are disposed closer to the longitudinal axis 42 that are the sides 40, 41 of the body 12. Although such is not deemed a critical aspect, the disposition of the side edges 43 and 44 of the head 16 are such that they are displaced equidistance toward the longitudinal axis 42 from the side edges 40, 41 respectively of the body 12. By such displacement a pair of guide rails are formed along the side edges 40 and 41 and lie in the plane defined by the flat body 12. Such is illustrated more clearly in the differential between the displacement of the side edges 40 and 43 as shown at 45 and the displacement differential between the side edges 41 and 44 as shown at 46. It can be seen that the displacements 45 and 46 essentially extend all along each of the two edges 40 and 41 of the body 12. As is seen in FIGS. 4 and 5, there are no interruptions by way of any protuberances extending outwardly from either of the two surfaces 24 and 26 of the body 12 along the two side edges 40 and 41. As a result, the guide rails as represented by the illustrations at 45 and 46 are adapted to fit within a pair of guide channels (not shown) formed within a power tool used to install the fastener. A power tool having such guide channels to receive the guide rails on the fastener 10 is disclosed in U.S. patent application Ser. No. _______ filed _______ for FASTENER POWER TOOL by the same inventors of this application and assigned to the same Assignee, which is incorporated herein by this reference. As is therein shown a plurality of fasteners such as defined herein are collated to provide a coiled supply thereof which is inserted into a magazine attached to the power tool. Each of the fasteners is moved into position by a traditional pawl mechanism to position the fastener so that the head 16 can be engaged by a drive mechanism. When the fastener is thus positioned, the guide rails 45 and 46 on the edges of the fastener are seated within a pair of guide channels which function to maintain the longitudinal axis 42 of the fastener substantially perpendicular to the work piece during the time the power tool drives the fastener through the work piece and through the metal substrate to a position such that the substrate and the work piece can be clamped together. This maintenance of perpendicularity of the longitudinal axis 42 of the fastener to the work piece has been found to be critical. If the longitudinal axis of the work piece deviates from the perpendicular by only a few degrees, then when the drive force is applied to the head 16 and the point 14 of the fastener engages the metal substrate the point will be carried along the surface of the substrate as opposed to immediately penetrating it. Although the point may ultimately penetrate the substrate a substantial amount of the force imparted by the power tool to the fastener is dissipated and the fastener in all probability will not seat to properly clamp the work piece and the substrate together.

As is illustrated in FIG. 4 the body 12 may be coined along the edges as shown at 22. The term coined or coining means that the thickness of the metal of the body along the edges is reduced by the application of extreme pressure. The coining generates a depression or channel which extends from adjacent the head 16 down both side edges of the body to and including the point 14 but displaced slightly from the side edges. Thus, coining as used in this application is intended to mean that the material on the surface 24 is compressed to form the channels as shown at 22 but in such a way that there is no protrusion of the metal of the body from the surface 26 thereof. The coining preferably is accomplished during the stamping operation which produces the fastener but may be performed separately, if desired. Such an operation work hardens the material causing it to be able to penetrate through the work piece and substrate easier without bending or otherwise deforming. In addition, as is illustrated in FIG. 4 the side edges of the body 12 are beveled as shown at 28 down through and including the point 14. Such beveling further simplifies and makes it easier for the fastener 10 to penetrate particularly through the metal substrate. It should be understood that the bevel formed on the edges forming the point 14 continues uninterrupted up the side edges of the body 12. Thus, when the point 14 cuts an opening in the metal substrate, it has a bevel shape at its edges into which the side edges of the fastener fit without the necessity of further cutting the substrate.

As is illustrated in FIG. 5, the body adjacent to and including a portion of the head has formed therein first and second stamped stiffening grooves 30 and 32. These grooves overlap the upper portions of the coining channel as illustrated in FIG. 5 which is taken about the lines 5-5 of FIG. 1 although such overlapping is not required. By the term stamped stiffening grooves, it is meant that the material of the body during the stamping operation which forms the body is deformed so that a groove is formed on the surface 24 and a protrusion is formed on the surface 26 as shown at 34. Also as shown in FIG. 5 the protrusion 34 continues around the bend 36 which forms the head 16 and onto the head. However, the protrusion does not extend from the surface 26 of the body 12 along that portion which penetrates the substrate.

As is shown particularly in FIG. 2, there is formed about the opening 36 a downwardly depending flange 38 which is utilized to cut through the surface of the work piece such as drywall to facilitate the head 16 positioning itself flush with the drywall surface without damaging the same.

By reference now to FIG. 6A, 6B and 6C there is illustrated installation of a fastener constructed in accordance with the present invention into a work piece positioned upon a metal substrate. As is therein shown, a work piece 62 such for example, as drywall, is disposed upon a metal substrate 64 of light gauge sheet metal. A worker 52 then positions a power tool 54 so that the nozzle 56 is adjacent a desired position for insertion of the fastener. A plate 58 is disposed beneath a cartridge 60 which receives the coiled collated fasteners as above described. The plate 58 provides the worker 52 with the ability to hold the power tool 54 so that the nozzle 56 is substantially perpendicular with the substrate 62. When the tool 54 is properly positioned at the desired point then the worker pulls the trigger causing the fastener 66 to penetrate through the work piece 62 and the metal substrate 64 in a manner such that the longitudinal axis of the fastener 66 is maintained substantially perpendicular throughout the entire time that the power tool drives the fastener through the work piece and substrate in such a manner that they are properly clamped together.

As is seen from the illustrations and the above description, there are no strengthening protrusions extending from the surface of the body 12 over that portion which penetrates through the metal substrate.

There has thus been disclosed a fastener for securing a work piece to a metal substrate which has guide rails along the edges thereof for cooperating with guide channels in a power tool for maintaining the fastener substantially perpendicular to the work piece during installation.

What is claimed is:

1. A fastener for securing a work piece to a metal substrate with a power tool comprising:
an elongated flat body having a longitudinal axis and including a point for penetrating said work piece and said substrate and having a width dimension and first and second outer edges;
a securing member carried by said body;
a head at one end of said body having a width dimension and being disposed at a substantially right angle to said body for use in driving said fastener through said work piece and said substrate; and
said width dimension of said body being greater than the width dimension of said head to provide at least one guide rail along one of said first and second outer edges for cooperation with said power tool to retain said longitudinal axis substantially perpendicular to said work piece during the time said power tool drives said fastener through said work piece and metal substrate.

2. A fastener as defined in claim 1 wherein said head includes first and second outer edges, each of said first and second outer edges on said head being disposed closer to said longitudinal axis than said first and said outer edges of said body to provide a pair of guide rails on said elongate body, one along each of said first and second outer edges.

3. A fastener as defined in claim 2 wherein said outer edges of said body are beveled.

4. A fastener as defined in claim 3 wherein said body is coined adjacent to but displaced from said outer edges of said body.

5. A fastener as defined in claim 4 wherein the outer edges of said body including said point are beveled.

6. A fastener as defined in claim 2 which further includes a first stamped stiffening groove disposed at a transition between said body and said head and extending from said transition along said body and said head.

7. A fastener as defined in claim 6 wherein said body is coined adjacent to but displaced from said outer edges of said body and said stamped stiffening groove extends along said body for a distance to overlap said coining.

8. A fastener as defined in claim 7 which further includes a second stamped stiffening groove laterally displaced from said first stamped stiffening groove.

9. A fastener as defined in claim 8 wherein said first and second grooves are each disposed substantially equidistance from said first and second edges of said body respectively.
